(19) United States
(12) Patent Application Publication
(10) Pub. No.: US 2002/0160843 A1
(43) Pub. Date: Oct. 31, 2002

(54) Joint boot

(76) Inventors: Nobuo Suzuki, Hiratsuka-shi (JP); Kazuyuki Kabe, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/079,908

(22) Filed: Feb. 22, 2002

(30) Foreign Application Priority Data
Feb. 23, 2001 (JP) JP2001-047963

(51) Int. Cl. F16C 1/26; F16D 3/84

(52) U.S. Cl. 464/175

(57) ABSTRACT

A joint boot for protecting a joint part of a power transmission system, in particular a joint boot for improving the durability by reducing a local stress concentration. The joint boot comprises a cylindrical bellows part, and annular mounting parts formed at both ends of the bellows part, a ridge portion and a bottom portion of said bellows part being formed in a continuous spiral shape.

### BACKGROUND OF THE INVENTION

The present invention relates to a joint boot for protecting a joint part of a power transmission system, and particularly to a joint boot for improving the durability by reducing a local stress concentration.

The joint boot is a sealing part for protecting a joint part of a power transmission system such as a car, an industrial machine, and prevents dust, water and the like from invading from the outside into the joint part.

In particular the joint boot mounted to a joint part for performing direction changes between an input shaft and an output shaft repeats such changes as it is compressed at a side part where the output shaft is bent to the input shaft and expanded at the opposite side part. Because of this, the joint boot of the prior art, as shown in FIG. 3, comprises a cylindrical bellows part 6 having alternately ridge portions 2 and bottom portions 3 in multiple stages. However, when the joint boot is repeatedly subjected to deformation due to compression and bending (expansion) by rotation with the joint part, a stress concentrates locally on a part of the bottom portion and sometimes leads to breakdown. Moreover, the partial stress concentration on the bottom portion also causes a problem of buckling that further lowers the durability. In particular, when mounting parts at both ends of the joint boot differ in diameter, the stress tends to concentrate on the bellows part in a vicinity of the mounting part with the smaller diameter and leads to breakdown early.

### SUMMARY OF THE INVENTION

An object of the present invention is to provide a joint boot enabling an improvement in durability by reducing a local stress concentration.

A joint boot of the present invention to attain said object is a joint boot comprising a cylindrical bellows part, and annular mounting parts formed at both ends of the bellows part, wherein a ridge portion and a bottom portion of the bellows part are formed in a continuous spiral shape.

Since the ridge portion and the bottom portion of the bellows part are formed in a continuous spiral shape, the compression stress and bending (expansion) stress are dispersed in the direction of a long continuous spiral, so that the local stress concentration can be reduced and further the buckling deformation can be eliminated. Accordingly, durability of the joint boot can be improved.

### BRIEF DESCRIPTION OF THE DRAWINGS

FIG. 1 is a side view showing a joint boot as an embodiment of the present invention.

FIG. 2 is a sectional view showing the joint boot of FIG. 1 being mounted to a joint part.

FIG. 3 is a side view showing a joint boot of the prior art.

FIG. 4 is a graph showing a relationship between load and compression when a joint boot is compressed.

FIG. 5 is a graph showing a relationship between bending moment and bending angle when a joint boot is bent.

### DETAILED DESCRIPTION OF THE PREFERRED EMBODIMENT

The present invention will be described below by referencing the embodiments shown in the attached drawings.

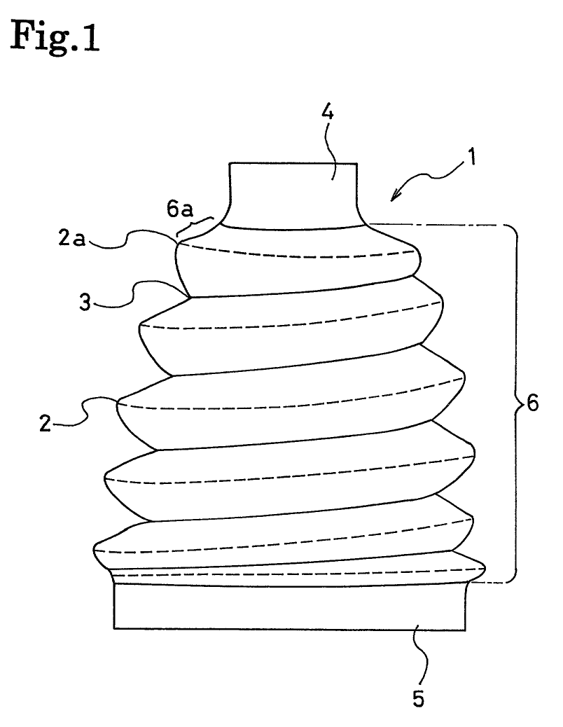

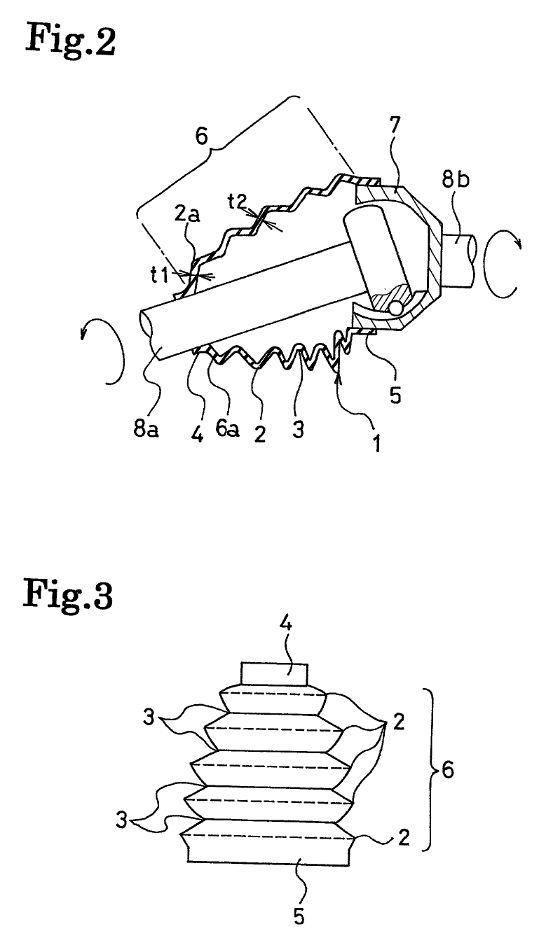

FIG. 1 illustrates a joint boot according to an embodiment of the present invention, and FIG. 2 shows the joint boot being mounted to a joint part of a power transmission system.

FIG. 1, a joint boot 1 has at both ends thereof annular mounting parts 4, 5 with different diameters, and is constructed in a manner that a cylindrical bellows part 6 is connected in a middle part thereof. The bellows part 6 has a ridge portion 2 and a bottom portion 3 that are formed in a continuous spiral shape from one mounting part 4 to the other mounting part 5.

As shown in FIG. 2, the joint boot 1 is mounted through the mounting part 4 and the mounting part 5 so as to seal the gap with regard to a joint part 7, which forms a connection between an output shaft 8a and an input shaft 8b so as to change directions thereof. Since the output shaft 8a and the input shaft 8b are bent at the joint part 7, the joint boot 1 that rotates together with the joint part 7 repeats such changes as it is compressed at a side part where the output shaft 8a is bent with regard to the input shaft 8b and expanded at the opposite side part.

The joint boot 1 generates alternately a compression stress and a tensile stress when it is subjected repeatedly to compression and bending (expansion) like this, but since the ridge portion 2 and the bottom portion 3 are spirally continuous, these stresses can be dispersed along the spiral, and local stress concentration can be reduced. Further, the buckling deformation can be eliminated.

In the present invention, preferably the wind number n of the spiral of the bellows part 6 be twice or more based on a peak point of the ridge portion 2. If the wind number n is less than 2, it is difficult to fulfill a function to protect the power transmission system in a bent shape. The upper limit of the wind number n is not particularly specified but is determined by the size (diameter and length) of a power transmission system to which the joint boot 1 is applied.

As shown in FIG. 2, for a joint boot in which the mounting parts 4, 5 at both ends differ in diameter, the stress tends to be biased to the smaller diameter side. That is, regarding the bellows part 6, the stress tends to gather in a zone 6a from the mounting part 4 of the smaller diameter to a first peak 2a of the ridge portion. As a measure to cope with this, preferably a thickness t1 in the zone 6a be made larger than a thickness t2 in another zone of the bellows part 6. By this, a rigidity of said zone 6a is made higher than a rigidity of another part of the bellows part 6 and the stress concentration is eased, and a durability of the joint boot 1 can be further improved.

Said thickness t1 preferably be set in a relation of 2.0 mm<t1<5.0 mm. t1≦2.0 mm is not preferable, since it lowers the strength of the joint boot and the durability. t1≧5.0 mm is not preferable, since it increases the weight.

For the relationship of said thicknesses t1 and t2, more preferably the ratio of t1 to t2 or t1/t2 be set in a relation of 1.4<t1/t2<2.5. When t1/t2≦1.4 is adopted, the part of the zone 6a is easily deformed to generate a local stress concentration, and when t1/t2≧2.5 is adopted, the part of the zone 6a is not easily deformed and the weight is increased, so both are not preferable.

In the above-illustrated example, a case in which mounting parts of both ends differ in diameter was described, but of course the present invention is applicable to a case in which both ends have the same-diameter mounting parts, too.

As a material used for the joint boot of the present invention, both the rubber and elastomer resin used for joint boots of the prior art can be used and not limited in particular. However, a thermoplastic elastomer, in particular a thermoplastic polyester elastomer, which is excellent in heat resistance and oil resistance, is preferable and further a blended compound of a rubber and a thermoplastic elastomer is preferable.

### EXAMPLE

With dimensions of mounting parts at both ends and the step number of the bellows part common to each other, and with only the shapes different from each other, joint boots were prepared, one as an embodiment (FIG. 1) and the other as an example for comparison (FIG. 3).

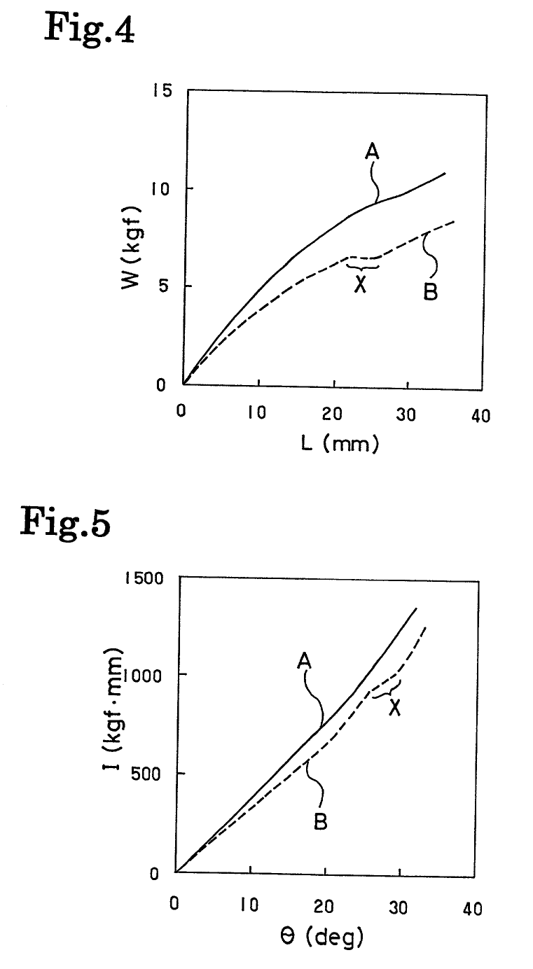

About these two types of joint boots, compression tests and bending tests were done by the following test methods, and the results are shown in FIG. 4 and FIG. 5.

Compression Test

Placing the joint boot vertically with the large-diameter mounting part set on a horizontal table, the relationship of load W and axial compression L, when the load is applied axially from the small-diameter mounting part side, is measured.

Bending Test

Fixing the joint boot vertically with the large-diameter mounting part set on a horizontal table, the relationship of bending moment I and bending angle θ, when a load is applied horizontally to the small-diameter mounting part side, is measured.

FIG. 4 is a load-compression (length) relationship graph, where test results are shown by curve A (embodiment) and curve B (example for comparison). From these test results, we can see that embodiment A has a higher rigidity to compression loads than the example for comparison B. Also, we can see that the example for comparison B has an unstable zone x when the load is around 6 kgf and tends to cause a local strain, such as buckling.

FIG. 5 is a bending moment-bending angle relationship graph, and likewise test results are shown by curve A (embodiment) and curve B (example for comparison). From these test results, we can see that embodiment A has a higher rigidity to bending loads than the example for comparison B. Also, we can see that the example for comparison B has an unstable zone x when the load is around 1000 kgf·mm and tends to cause a local strain, such as buckling.

Also, by causing buckling in these joint boots of the embodiment and example for comparison, the stress concentration level is compared. Setting the example for comparison as 100, results of the embodiment are shown in Table 1. We can see that the stress concentration level of the embodiment is lower than the example for comparison.

TABLE 1

| | Embodiment | Example for comparison |
|---|---|---|
| Stress concentration level | 99.3 | 100 |
| (index) due to compression | | |
| Stress concentration level | 84.7 | 100 |
| (index) due to bending | | |

Incidentally, the stress concentration level, when bucking is generated in a joint boot, refers to the level of stress concentration caused at the buckling point, and here the strain energy E (E=½·σ·ε) per unit volume is calculated as a scale (σ:stress, ε:strain).

As described above, it can be seen that the joint boot of the embodiment disperses the compression and bending stress along a long spiral, thereby reducing a local stress concentration.

According to the present invention, as described above, since the ridge portion and the bottom portion of the bellows part of the joint boot are formed in a continuous spiral shape, it is possible to disperse compression stress and bending (expansion) stress and reduce a local stress concentration, and what is more, since a buckling deformation can also be avoided, durability of the joint boot can be improved.

The preferred embodiment of the present invention was described in detail as above, however, it should be understood that various modifications, substitutions and replacements can be applied to this, within the spirit and scope of the present invention as stated in attached claims.

What is claimed is:

1. A joint boot comprising; a cylindrical bellows part and annular mounting parts formed at both ends of said bellows part, wherein a ridge portion and a bottom portion of said bellows part are formed in a continuous spiral shape.

2. A joint boot as claimed in claim 1, wherein said both mounting parts differ in diameter each other, and a thickness t1 of said bellows part in a zone from a mounting part of the smaller diameter to a first peak of said ridge portion is made larger than a thickness t2 of said bellows part in another zone.

3. A joint boot as claimed in claim 2, wherein the ratio of the thickness t1 to the thickness t2 is set in a relation of 1.4<t1/t2<2.5.

4. A joint boot as claimed in claim 3, wherein said thickness t1 is set in a relation of 2.0 mm<t1<5.0 mm.

5. A joint boot as claimed in claim 1, wherein said ridge portion and said bottom portion of said bellows part are formed in a continuous spiral shape from one mounting part to the other mounting part.

6. A joint boot as claimed in claim 1, wherein the wind number of the spiral of said bellows part is twice or more.
